(19) United States
(12) Patent Application Publication
(10) Pub. No.: US 2012/0183926 A1
(43) Pub. Date: Jul. 19, 2012

(54) DENTAL TREATMENT APPARATUS AND METHOD

(76) Inventor: Pinchas SHALEV, Herzeliya (IL)

(21) Appl. No.: 13/180,985

(22) Filed: Jul. 12, 2011

Related U.S. Application Data
(60) Provisional application No. 61/433,281, filed on Jan. 17, 2011.

(51) Int. Cl. A61C 19/06; B67D 7/74

(52) U.S. Cl. 433/215; 222/129; 222/1

(57) ABSTRACT

An apparatus is disclosed for providing dental care using pressurized fluid. The pressure is obtained from the effervescence effect of the reaction of two active materials in the presence of the fluid. The pressurized fluid is provided to the mouth in a constant pressure and the apparatus is handy and may be operated in any angle with respect to the direction of earth gravity force. In some operational modes the pressurized fluid is provided in pulsating manner or in vibrating manner or in both manners.

### CROSS-REFERENCE TO RELATED APPLICATIONS

This Application claims the benefit of U.S. Provisional Application Ser. No. 61/433,281, filed Jan. 17, 2011, which is hereby incorporated by reference in its entirety.

### BACKGROUND OF THE INVENTION

A number of devices for dental treatment and cleansing of the mouth, teeth and gums using pressurized liquid are known in the art. One type comprises mechanical pressurizing means such as motor driven mini pump. Such devices require electrical power source which require either connection to wall socket and involves electrical shock hazard, or portable electrical devices requiring continuous replacement of batteries.

### SUMMARY OF THE INVENTION

According to embodiments of the present invention an apparatus is disclosed comprising a container partitioned into a first compartment and a second compartment by a partition adapted to allow free flow of liquid through said partition, said first compartment adapted to contain liquid, said second compartment adapted to receive a first and a second active material, a back cover adapted to close a first end of said container, said first end is closer to said second compartment; and an operation control means to control dispensing of pressurized liquid from said container, said operation control means installed on a front cover closing the second end of said container, wherein said first active material and said second active material to produce a first pressure from an effervescence process when in a chemical reaction and said operation control means to reduce said first pressure to a second pressure, said second pressure is kept constant regardless of the orientation of said container with respect to the gravity direction. According to further embodiments of the present invention the apparatus comprising dispensing tube connected at a first end to said operation control means to receive pressurized liquid in said second pressure and to dispense said pressurized liquid via a dispensing orifice. The apparatus further comprising pulsating mechanism to provide the pressurized liquid to the dispensing orifice in at least one pulse. The number of said pulses in a time interval is controllable.

### BRIEF DESCRIPTION OF THE DRAWINGS

The subject matter regarded as embodiments of the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically describes apparatus for providing pressurized liquid to clean the interior of the mouth, according to embodiments of the present invention;

FIG. 1A, depicts the apparatus of FIG. 1 during re-fill operation, according to embodiments of the present invention;

FIG. 2, schematically illustrates liquid flow control means, according to embodiments of the present invention;

FIGS. 3A, 3B and 3C depict apparatus of FIG. 1 in respective three different angles of inclination and their respective formation of feed tube, ensuring that the distal end remains submerged in the liquid in the apparatus, according to embodiments of the present invention;

FIG. 4 schematically depicts partial cross sectional view of the end of a dispensing tube, according to embodiments of the present invention;

FIG. 5, is a partial cross sectional view of pulsating flow control mechanism for providing pulsating flow, according to embodiments of the present invention;

FIGS. 6A, 6B and 6C are schematic illustrations of various types of containers are made to get smaller when not in use and get bigger when in use, according to embodiments of the present invention;

FIGS. 7A, 7B and 7C schematically illustrate a dental treatment hand tool in partial isometric view, partial top view and partial side view which is partially transparent, respectively, according to embodiments of the present invention;

FIGS. 8A and 8B are schematic partial cross section top and side views of a hand tool for cleansing the teeth and mouth according to embodiments of the invention;

FIG. 8C is a schematic isometric view of the hand tool of FIGS. 8A and 8B with added brush ring, according to embodiments of the present invention;

FIGS. 9A and 9B are partial cross section side view and isometric view of a hand tool according to embodiments of the present invention; and

FIG. 10 is a schematic partial cross section side view of a hand tool according to embodiments of the present invention.

FIG. 11 is a flow diagram depicting operation of a dental care apparatus according to embodiments of the present invention

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to embodiments of the present invention the well known phenomena of the effervescence effect of the chemical reaction of certain first and second materials, such as baking soda (sodium bicarbonate) with certain other materials, such as citric acid (C₆H₈O_{7(aq)}) may be utilized in treatment of the hygienic of the mouth to achieve improved treatment results with respect to the depth of penetration of treating materials into cavities in the mouth and between the teeth and the gums. The first material may be a base with low value of pH, for example lower than 7 and the second material may be acidic with high value of pH, for example higher than 7. As is well known the chemical reaction of baking soda with citric acid is defined by:

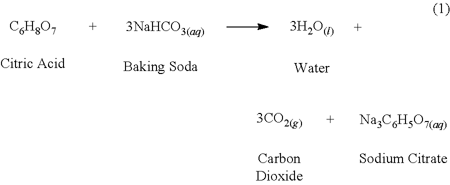

Similarly, the chemical reaction of tartaric acid with sodium bicarbonate is defined by:

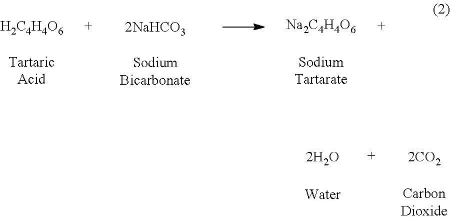

This phenomenon may be utilized, according to embodiments of the present invention, by using the gas that is released during the reaction (e.g. CO₂) to pressurize liquid in a container and to dispense that pressurized liquid for hygienic treatment of the mouth.

The effect of the use of pressurized liquid, according to embodiments of the present invention, additional to the increased mechanical impact of the pressurized liquid on removal of dirt and germs from cavities in the mouth, is the effect of ingredients of the reacting materials and/or of materials resulting from the reaction, such as baking soda granules, in providing further improved cleansing affect, acting as emery paper on surfaces in the mouth. The treating material may be, according to embodiments of the present invention, merely the granules of the first active material, e.g. baking soda or sodium bicarbonate. In some embodiments the treating material may also contain granules of one or more of materials produced during the chemical reaction. It will be appreciated by a person skilled in the art that other solutions may be used, which, when reacting, create effervescence effect.

It will also be apparent to a person skilled in the art that the first and/or second materials may be provided in any adequate phase or form, e.g. solid, powder, liquid or gel—as long as their chemical reaction will release gas to provide pressurized liquid and, preferably, granules. In some embodiments at least one of the first and second active materials may be provided in liquid form e.g. dissolved in water or the like. The liquid in which one of the active materials is dissolved may be used, according to embodiments of the present invention as the liquid to be pressurized. According to some preferred embodiments the first and second active materials may be provided in solid form. For example, the first and/or the second active materials may be provided in powder form, packed in a porous bag (such as a tea bag).

According to other or additional embodiments the first and/or the second active materials may be provided in a compressed form, such as in a tablet form. The active materials may be provided in any combination of powder and tablet: powder/powder, powder/tablet, tablet/tablet and even may be provided in a single solid package, such as a tablet, comprising the first and the second active materials. Hereinafter in the description of the invention, when the first and/or second active materials are described as provided in the form of a tablet it should be understood that providing each one of this materials in the form of powder, as explained above, is an alternative. The first and second active materials may be activated to create a chemical reaction in the presence of a liquid, such as water. The packaging of the first and second materials may be so that when exposed to liquid, such as water, the active materials dissolve in the liquid and chemical reaction begins.

According to additional embodiment the activating liquid may be used also to provide treating materials to the treated mouth, such as disinfection, freshening and the like. The chemical features of such activating liquid may be selected as may be desired, e.g. to have no effect on the chemical reaction, to release one or more product materials that has positive effect on the treated mouth, as may be required, etc.

For effective operation of pressurized liquid in cleansing internal surfaces of the mouth the pressure of the pressurized liquid should preferably be within a defined range during the operation, regardless of the remaining amounts of the active materials resulting, during the chemical reaction, the effervescence. According to embodiments of the present invention the type of active materials and their initial amounts may be selected to provide, within the volume of their container, pressure within a first range of pressures, which is higher at all times than the pressure within a second range of pressures of the pressurized liquid dispensed in the mouth. The pressure created in said container may be reduced, for example using a pressure regulator, to meet the required second range of pressures thus ensuring that the pressure of the dispensed liquid into the mouth will remain substantially constant as long as the pressure in the container is higher than, or equal to the pressure of the liquid dispensed in the mouth.

According to yet further embodiments of the present invention the continuing decrease in the size of the granules of the reacting first material, e.g. baking soda, due to the chemical reaction, may be utilized for continuous refining of the level of dirt and germs removal, resulting in refined smoothness of the internal surfaces of the mouth, teeth and gums at the end of the treatment. This may last as long as the emery paper effect of the particles is effective for removal and/or smoothing the treated surfaces. According to embodiments of the present invention the initial size of the granules of the first material may be selected for treatment with a defined level of initial dirt removal capacity and the rate of granules size reduction may be controlled to fit the specific treatment needs. It will be appreciated by a person skilled in the art that other solutions may also be used according to embodiments of the present invention which, when reacting, act on the granules of at least one active material to reduce their size during the reaction.

### Tablet/Powder Compositions and Additives

According to embodiments of the present invention the effervescent producing first material may be provided in the form of a tablet that may have defined form, that may contain the required materials for achieving the required treatment goals as is described in details herein below. The term ‘tablet’, as used throughout this specification, relates to material or materials that are adapted to participate in a chemical reaction and that are provided in a solid form, having a defined shape, where not all of the materials contained in the tablet necessarily adapted to participate in that chemical reaction. Additionally to treatment effects according to the present invention that were mentioned above, tablets made according to embodiments of the invention may comprise, additionally to the first and/or second active materials, materials for treating mouth internal surfaces, for providing odors, for providing vitamins, for providing disinfecting materials, etc. The amount of each of the ingredients in a tablet, as well as their order of release, their level of solubility and other respective features may be set so as to fulfill the treatment goals it is designed for, as is explained in details below.

### Compositions of Effervescent Tablet/Powder

The choice of ingredients for effervescent granules may be deducted both by the requirement of the manufacturing process and the necessity of making a preparation which dissolves in water. The required ingredients are at least one acid and at least one base. The base should release, according to embodiments of the present invention, carbon dioxide upon reaction with the acid. Examples of such acids may include tartaric acid and citric acid. Examples of bases include sodium carbonate, potassium bicarbonate, sodium bicarbonate. Effervescent granules may usually be prepared from a combination of citric and tartaric acid rather than from a single acid because the use of either acid alone may cause difficulties. When tartaric acid is the sole acid, the resulting granules readily crumble and lack mechanical strength. Citric acid alone may result in a sticky mixture which is difficult to granulate during the manufacturing process. Effervescent salts may include the following ingredients, which may actually produce the effervescence: sodium bicarbonate, citric acid and tartaric acid. When added to water the acids and base may react to liberate carbon dioxide, resulting in effervescence. It should be noted that any acid-base combination which results in the liberation of carbon dioxide could be used in place of this combination as long as the ingredients are suitable for pharmaceutical use.

The reaction between citric acid and sodium bicarbonate and tartaric acid and sodium bicarbonate, which results in liberation of carbon dioxide, has been shown above in formulas (1) and (2). It should be noted that it requires 3 molecules of sodium bicarbonate to neutralize 1 molecule of citric acid and 2 molecule of sodium bicarbonate to neutralize 1 molecule of tartaric acid. The proportion of acids may be varied, as long as the total acidity is maintained and the bicarbonate completely neutralized. Usually it is desired that ratio of citric acid to tartaric acid equals 1:2 so that the desired ratio of the ingredients can be calculated as follows:

Citric acid: Tartaric acid: Sodium bicarbonate=1:2:3.44 (by weight) (3)

The United States Pharmacopeia (USP) 24 includes the following seven monographs, that may be used for tablets according to embodiments of the present invention:

### 1. Acetaminophen for Effervescent Oral Solution;

### 2. Aspirin Effervescent Tablets for Oral Solution;

### 3. Potassium Bicarbonate Effer-vescent Tablets for Oral Solution;

### 4. Potassium Bicarbonate and Potassium Chloride for Effervescent Oral Solution;

### 5. Potassium Bicarbonate and Potassium Chloride Efferves-cent Tablets for Oral Solution;

### 6. Potassium and Sodium Bicarbonates and Citric Acid for Oral Solution; and

### 7. Potassium Chloride, Potassium Bicarbonate, and Potassium.

U.S. Pat. No. 3,566,863 to Law discloses a device for cleaning and washing teeth and gums using pressurized liquid. However this device requires, for the ensuring of a constant pressure in its container, that the surface of the liquid in the container will be substantially perpendicular to the container's longitudinal axis and that the shape of the container will be conical. These limitations cause the use of that device to be inconvenient and cumbersome. For the comfort of use of an apparatus for providing pressurized liquid for cleansing the mouth that apparatus should be of small size, hand-held, allowing the flexibility of pointing the tip that dispenses the pressurized liquid onto substantially any surface or cavity in the mouth. Preferably, the design and size of that apparatus should provide comfort for use also away from home, such as on the travel. Thus, it is required to ensure that the apparatus will be operable at any orientation with respect to the direction of earth gravity and that the orientation of the upper surface of the liquid contained in it will have substantially no effect on its operation.

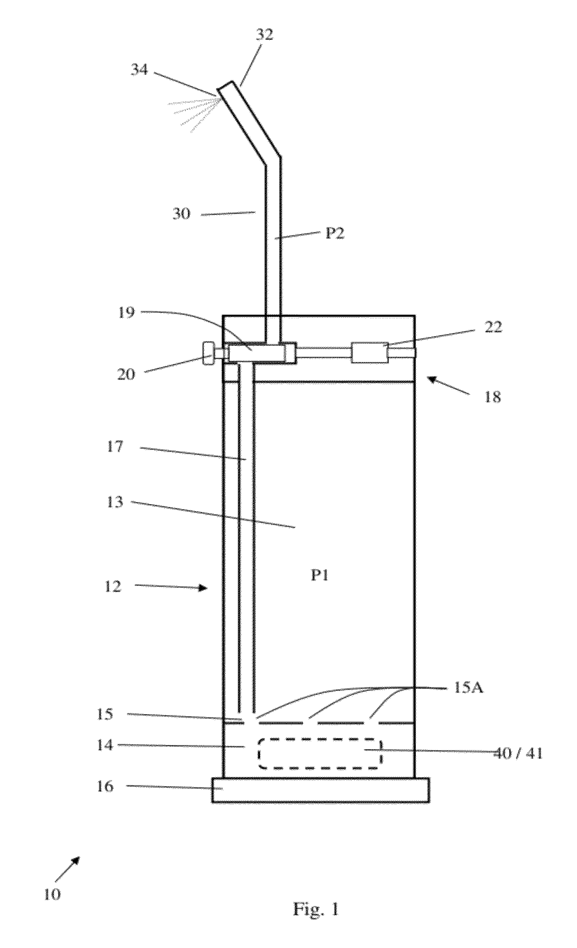

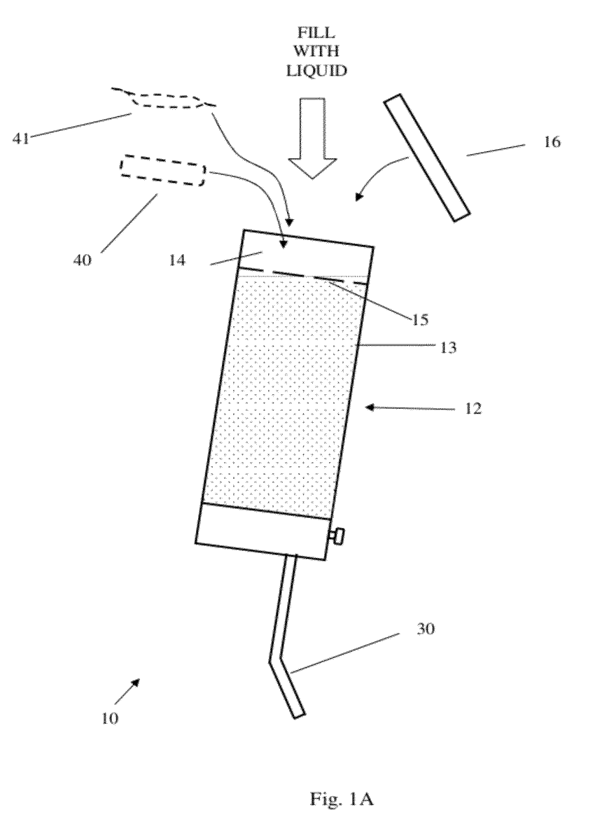

Reference is made now to FIG. 1 which schematically describes apparatus 10 for providing pressurized liquid to clean the interior of the mouth, according to embodiments of the present invention. Apparatus 10 comprise container 12 which is partitioned by partition 15 to first space 13 and second space 14. Partition 15 is made with one or more passages 15A allowing free flow of liquid, such as water, in container 12 through partition 15. Second space 14 is adapted to contain and hold solid body, such as tablet 40 or powder bag 41. Passages 15A may be designed to not allow tablet 40/powder bag 41 to pass through partition 15 at least when tablet 4040/powder bag 41 is in its initial size.

Apparatus 10 comprises, at one end of container 12, close to space 14, a removable/openable cap 16 adapted to seal container 12 when closed and allowing filling of liquid into spaces 13 and 14 and insertion of tablet 4040/powder bag 41 into space 14 when removed or opened. Apparatus 10 further comprises, at the other end of container 12, liquid flow control means 18. Flow control means 18 may comprise pressure regulator and open/close assembly 19, providing step-down pressure regulation and liquid flow open/close valve. The open/close valve may be operated by pressing or releasing open/close button 20. The pressure regulator of assembly 19 receives pressurized liquid via input tube 17 at a first pressure P1 and provides pressurized liquid to dispensing tube 30 at a second pressure P2, lower than P1. Flow control means 18 may further comprise pressure safety valve 22, adapted to bleed gas and/or pressurized liquid from container 12 when the pressure inside container 12 exceeds certain level of pressure P3, higher than said first pressure P1.

Reference is made now also to FIG. 1A, depicting apparatus 10 during re-fill operation, according to embodiments of the present invention. When apparatus 10 is to be prepared for operation e.g. by filling/refilling it with liquid 50 and/or by inserting new tablet 40/powder bag 41 it may be turned so that the end of container 12 close to compartment 14 is facing up, then cap 16 may be opened and through the opening liquid 50 may be poured into container 12 to fill it to a desired amount and then tablet 40/powder bag 41 may be placed in compartment 14 and cap 16 may be closed again. In order to control the time when effervescence starts the upper level of liquid 50 should be kept below partition 15 when apparatus 10 is turned upside down (as in FIG. 1A) to ensure that tablet 40/powder bag 41 remain separated from liquid 50 thus preventing the beginning of chemical reaction immediately when tablet 40/powder bag 41 is inserted into container 12. After refill ends and cap 16 is hermetically closed apparatus 10 may remain held upside down until beginning of chemical reaction and production of pressurized liquid is required.

Reference is made now also to FIG. 1B, depicting apparatus 10 after it has been refilled and the chemical reaction has been activated by turning apparatus 10 back, to have liquid 50 flooding tablet 40/powder bag 41, bringing the pressure inside container 12 to the level of P1.

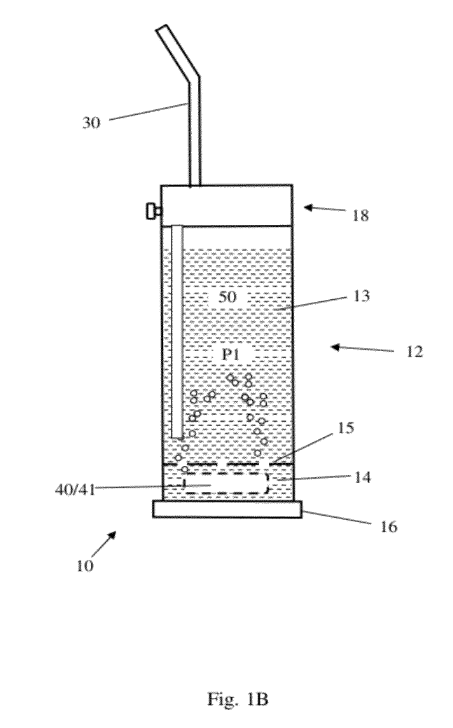

Reference is made now to FIG. 2, which schematically illustrates liquid flow control means 200, according to embodiments of the present invention. Flow control means 200 may comprise flow on/off and pressure regulating means 210 and safety bleed valve 250. Flow control means 200 may be installed at the end of the liquid container, such as container 12, opposite to the filling cap end. Control means 200 may comprise pressure chambers 204A and 204B being part of pressure regulating means 210 and pressure chamber 206, being part of safety bleed valve 250. Chambers 204A and 204B are partitioned by partition 215. Partition 215 may have orifice 217 in it. Orifice 217 may be adapted to fully block against flow of pressurized liquid and/or gas from chamber 204A to chamber 204B by valve 214. Valve 214 may have a conical portion adapted to fully block orifice 217 when it is forced onto the orifice for example by the force of retuning spring 216. Due to the conical shape of valve 214 the actual size of cross section area of a passage opened in partition 215 when the conical part of valve 214 is pushed gradually away from partition 215 gradually grows respectively. Valve 214 may be pushed to gradually open the passage through partition 215 by pressing on/off/pressure regulation button 212.

Pressurized liquid and/or gas may enter chamber 214A from container 12 via feed tube 17 and through opening 211. When valve 214 fully blocks orifice 217 no flow of pressurized liquid/gas towards dispensing tube 230 is possible. Since dispensing tube 230 has a dispensing orifice 234 made in its distal end the pressure in chamber 204B and dispensing tube 230 equals to the atmospheric pressure. When on/off/pressure regulation button 212 is depressed passage in partition 215 is opened, the size of it is determined by the amount of depression of button 212. As a result, pressurized liquid and/or gas may enter chamber 204B and, via opening 204C, flow through dispensing tube 230 towards dispensing orifice 234 made at the distal end 232 of dispensing tube 230. Selection of the size of dispensing orifice 234 versus the range of sizes (from fully blocked to fully opened) of passage 215 may determine the amount of pressurized liquid/gas flowing towards dispensing orifice 234 and thereby—determine the pressure developing in dispensing tube 230. The bigger the size of passage 215 the bigger is the amount of pressurized liquid/gas that is allowed to flow via chamber 204B towards dispensing orifice 234 and, as a result, the higher is the pressure P2 developing in chamber 204B, dispensing tube 230 and the entry to orifice 234. It will be appreciated that the pressure P2 developing in chamber 204B will always be lower than the pressure P1 in chamber 204A. Thus, according to embodiments of the present invention, valve 214 may be formed as an on/off valve (with no gradual control) depressing of on/off button 212 will result dispensing of pressurized liquid/gas from dispensing orifice 234, as long as the supply pressure P1 is high enough to maintain the pressure equation.

Safety bleed valve 250 may comprise inlet chamber 206 having inlet opening 206A and outlet opening 253. Pressure in chamber 206 equals to pressure P1 developing in container 12. Outlet opening 253 of chamber 206 is blocked by valve 256 and seal 254, such as an O-ring. Valve 252 tightly blocks opening 253 due to the pulling force exerted by spring 256. When pressure P1 exceeds certain safety pressure level P_{safety1} the pressure acting on valve 252 defeats the tightening force of spring 256 and safety valve 252 opens to bleed excess amounts of pressurized liquid/gas, until the momentary value of pressure P1 drops below certain pressure P_{safety2}, typically lower than P_{safety1}, and safety valve 252 closes again. It will be appreciated that other forms and designs of on/off/regulation mechanism and of safety mechanism may by used in embodiments of the present invention, as long as control of the operation of pressurized liquid dispensing and of safety means for preventing over pressure from developing in container 12 are ensured.

According to embodiments of the present invention the types and amounts of the first and second active materials, the chemical reaction between which creates the effervescence, may be selected to ensure, during most of the time of use, gas production capacity larger than needed to be provided through dispensing orifice 234. Thus, according to embodiments of the present invention, selection of the first and second active materials may develop first pressure P1 in the range of 20-200 psi. It will be noted that when the first pressure range P1 exceeds certain value (which is lower than P_{safety}) the high pressure may lower the rate of the chemical reaction and even stop it completely, since the pressure P1 acting on the liquid surface, oppresses the chemical reaction. According to embodiments of the present invention the range of pressure P2 required for dispensing into the mouth may be in the range of 5-100 psi. In order to maintain proper balance between the flow rate of pressurized liquid from container 12 towards dispensing orifice 234 so that the required amount of pressurized liquid, in the required range of pressures, may be maintained substantially through the period of operation, the area of orifice 234, according to embodiments of the present invention, may be 0.6-0.8 square mm. In order to provide a full mouth treatment and cleansing the amount of liquid in container may be in the range of 100-1000 milliliter (ml).

In order to ensure continuous supply of pressurized liquid in substantially any inclination angle of container 12 with respect to the direction of earth gravity, feed tube 17, which is adapted to provide pressurized liquid to regulator and open/close assembly 19 (FIG. 1) or pressure regulating means 210, may be made of a flexible material, such as plastic or rubber. Further, feed tube 17 may have a small weight 17B installed at its distal end 17A through which liquid may enter. The weight may ensure that feed end 17A of feed tube 17 will remain submerged in liquid in container 12 at substantially any inclination of the container.

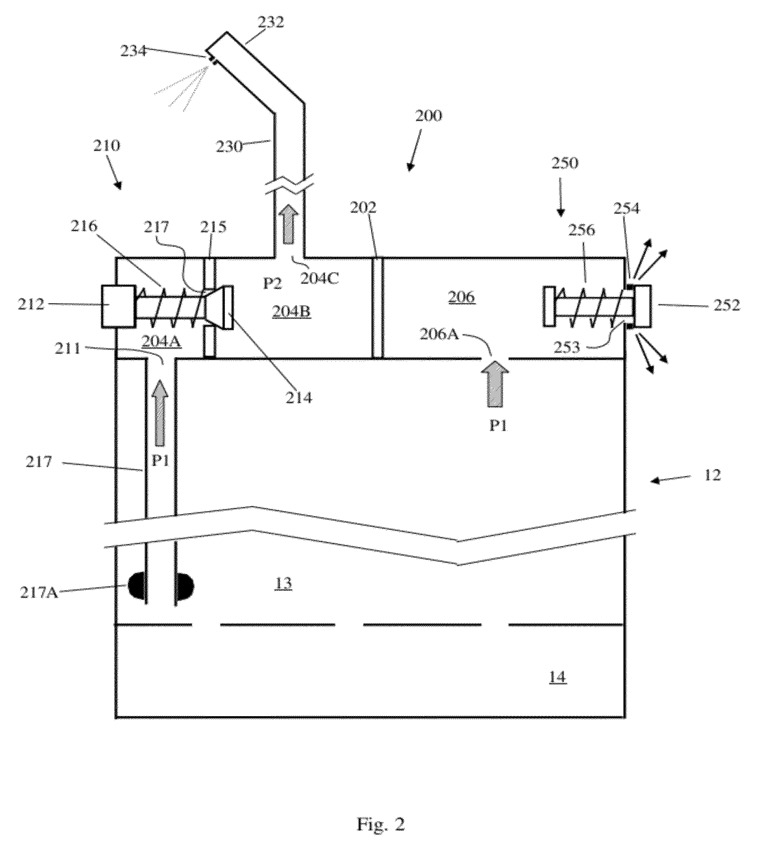

Reference is made now to FIGS. 3A, 3B and 3C which depict apparatus 10 in three different angles of inclination and their respective formation of feed tube 17 due to the installation of weight 17B at its distal end, to ensure that the distal end remains submerged in the liquid in apparatus 10, according to embodiments of the present invention. This way supply of pressurized liquid to regulator and open/close assembly 19 (FIG. 1) or pressure regulating means 210 may be ensured until the liquid in apparatus 10 substantially runs out.

In order to further improve and enhance the cleansing effect of apparatus, such as apparatus 10, the flow of pressurized liquid through its dispensing orifice, such as dispensing orifice 234 (FIG. 2) may be provided in pulses, e.g. the liquid may be provided and stopped repeatedly in very short terms. According to embodiments of the present invention pulse rate in the range of 1000-4000 pulses per minute (ppm) may have good cleansing effect and more preferably pulse rate of in the range of 1200-1600 ppm will have excellent cleansing effect.

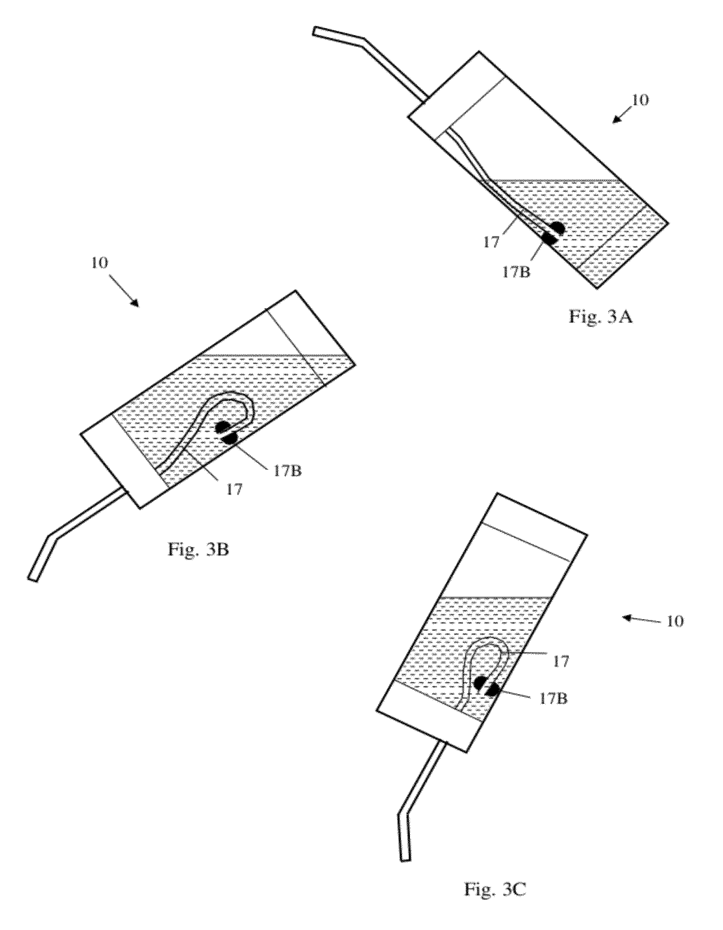

Reference is made now to FIG. 4 which schematically depicts partial cross sectional view of the end of dispensing tube 400, according to embodiments of the present invention. Dispensing tube 400 may have installed therein a spatial helix element 404 configured as a long-pitch thread or worm having a longitudinal axis coinciding with the longitudinal axis of the inner bore 402 of dispensing tube 400 and having an outer diameter which smoothly fits the inner diameter of bore 402 to allow smooth rotation of helix element 404 inside bore 402. Helix element 404 may have, according to embodiments of the present invention, an auxiliary axis 404A made at the end of helix element 404 closer to the tip 401A of dispensing tube distal end 401. Auxiliary axis 401A may be located in a cylindrical bore made at the end of bore 402 and on its longitudinal axis, to provide improved support to helix 404 when it turns about its longitudinal axis.

Pressurized liquid entering into dispensing tube 400 via bore 402 aiming to leave via dispensing outlet orifice 406 flows over helix element 404 and causes it to rotate rapidly about its axis. As a result sections 410 of the blades of helix element 404 pass over, and close to, the inner end of orifice 406 thus causing intermittent break of the flow of pressurized fluid through orifice 406. The number of such breaks in the flow of the pressurized fluid equals, substantially, to two times the rotational speed of helix element 404. For example, if helix element 404 turns at a speed of 500 RPM (rounds per minute) the pressurized fluid 420 exiting orifice 406 will experience 500×2=1000 breaks (or pulses) per minute, that is the pressurized fluid 420 exiting orifice 406 has 1000 pulses per minute.

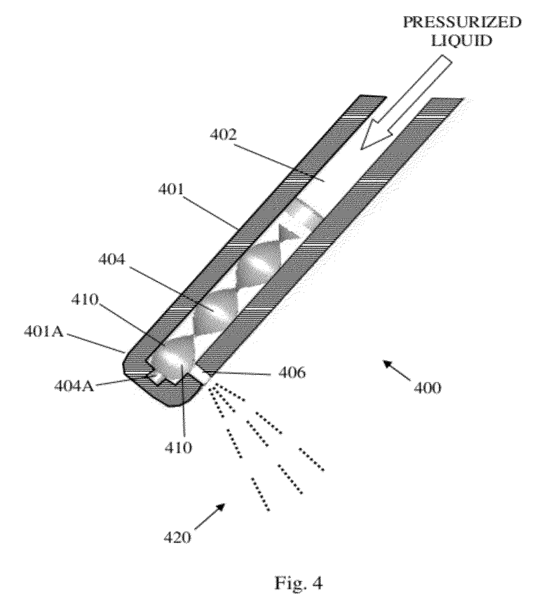

Reference is made now to FIG. 5, which is a partial sectional view of pulsating flow control mechanism 500 for providing pulsating flow, according to embodiments of the present invention. Pulsating flow control mechanism may comprise pressurized fluid inlet tube 502 feeding fluid cylinder 504 having two chambers. First cylinder chamber 504A located next to inlet 502 and second cylinder chamber 504B located at the end of cylinder 504 distal from inlet 502. Chambers 504A and 504B are partitioned from one another by piston 506 and pin 508. Piston 506 slidably moveable along cylinder 504 (right/left in the orientation of FIG. 5 on the page) thus changing the momentary volumes of chambers 504A and 504B. Spring 510 is installed so that when piston 506 moves away from inlet 502 spring 510 depresses and vice versa. Pin 508 is slidably installed in a respective bore in piston 506 allowing smooth movement of pin 508 right/left in the bore of piston 506. The axis of movement of piston 506 and of pin 508 coincide with each other. An outlet orifice 512 is made in the end of cylinder 504 distal from inlet 502. Piston 506 and pin 508 are made so that when, due to the movement of piston 506 and pin 508 away from inlet 502 pin 508 hits the distal wall of cylinder 504 and its distal end blocks orifice 512, preventing flow of pressurized fluid, when the force pressing pin 508 against the distal end of cylinder 504 is strong enough. A second orifice 520 is made through piston 506, allowing slow flow of fluid from one side of piston 506 to its other side, according to the balance of pressures on both sides of piston 506.

Pulsating control mechanism 500 received pressurized fluid via inlet 502. At this stage piston 506 and pin 508 are located away from outlet orifice 512 due to the returning force exerted by spring 510. As fluid continue entering chamber 504A piston 506 along with pint 508 are depressed towards outlet orifice 512 and as a result loading spring 510 with tension force. Assuming that activation mechanism 530 is in its “ON” position free flow is allowed from outlet orifice 512 towards dispensing tube 540. Thus, there is no counterforce developing in chamber 504B of cylinder 504 and piston 506 with pin 508 are free to move towards outlet orifice 512, experiencing only the growing counterforce of depressing spring 510. At a certain stage, pin 508 is depressed against orifice 512 strongly enough to cause complete blockage of outlet orifice 512. Now the pressure in chamber 504B begins to build up due to fluid entering this chamber through second orifice 520, while the pressure in chamber 504A is constant and equals to the pressure provided through inlet 502. At a certain second stage, the pressure built in chamber 504B together with the returning force of depressed spring 510 passes the force exerted on piston 506 by the pressurized fluid in chamber 504A and as a result piston 506 and pin 508 withdraw from outlet orifice 512, allowing the pressurized fluid in chamber 504B to burst through outlet orifice 512, via activation mechanism 530 into dispensing tube 540. Once the fluid trapped in chamber 504B bursts out via outlet orifice 512, the pressure on piston 506 and pin 508 exerted from chamber 504A overcomes the force of spring 510 and the operation described above happens again. As a result, as long as activation mechanism 530 is in “ON” position and pressurized fluid is supplied via inlet 502, pulses of pressurized fluid will be created and provided to dispensing tube 540. The rate of pulses (in pulse-per-minute) and the amount of pressurized fluid in each pulse may be determined, for example, by selecting the volumes of chambers 504A and 504B, the pressure of pressurized fluid, the spring constant of spring 510 (and its bias tension), etc.

According to additional or alternative embodiment pulsating control mechanism 500 may be further provided with a “one shot” mechanism (not shown) that when it is set to “one shot” mode and ON/OFF button is pressed, a single pulse of pressurized fluid will be dispensed through dispensing orifice 234. When the “one shot” mechanism is set in “burst” mode continuous dispensing of pulsating pressurized fluid is provided.

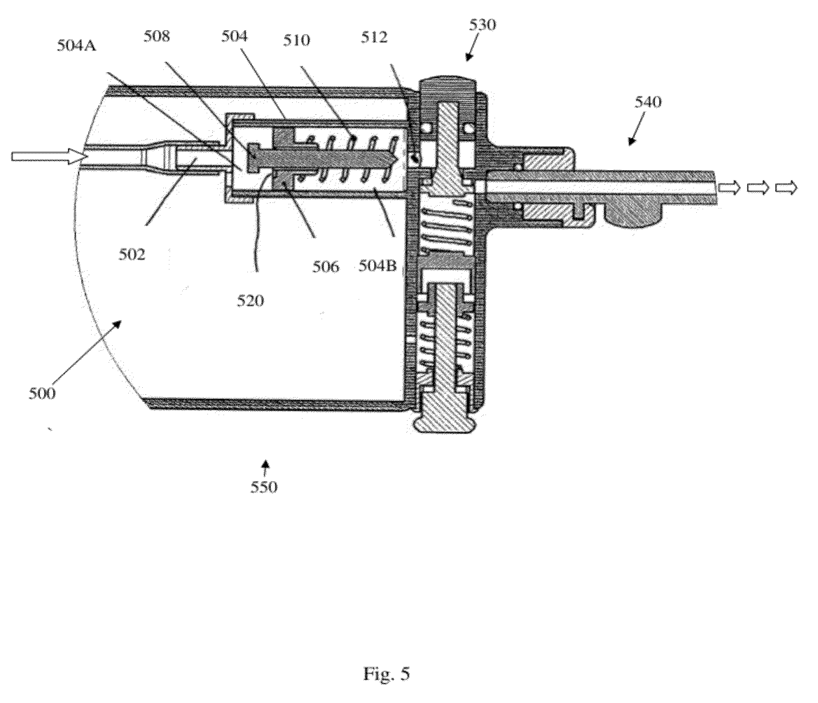

In order to make a dental and mouth cleansing tool portable and easy to store or to take when on a trip, its biggest part, the liquid container, should be formed so that when it is not in use it will occupy small volume, at least smaller than its in-use volume. Reference is made now to FIGS. 6A, 6B and 6C which are schematic illustrations of various types of containers 600A, 600B and 600C which are made to get smaller when not in use and get bigger when in use, according to embodiments of the present invention. Container 600A is made of two cylindrical elements 610A and 610B, which are made to collapse into one another (element 610A is collapsible into element 610B in the example of FIG. 6A) so that the volume of container 600A may be about half its fully extended size when collapsed. When elements 610A and 610B are extended with respect to one another they are made to have the common circumference sealed so that pressure developing inside container 600A may not leak through the connection between elements 610A and 610B.

FIG. 6B presents additional embodiment in which container 600B may collapse when not in use to occupy a volume much smaller than the volume of a fully extended container. Container 600B may comprise a plurality of conical elements 620A, 620B . . . 620E, which are made to collapse into each other when in collapsed mode and to extend to a full volume of container 600B when in use. Elements 620A, 620B . . . 620E may be of the form of cones which match each other's matching lips so as to provide sufficient sealing when extended, similarly to the seal between elements 610A and 610B as explained above. It will be noted that the specific form of elements 620A, 620B . . . 620E may be cones with slight inclination angle or cylindrical elements, as may be required. When container 600B in collapsed form its volume is very low and thus it suits placing in confined spaces or may easily serve as essential equipment for trips.

FIG. 6C presents container 600C made of plurality of bellows elements which are formed so that when container 600C is empty of liquid and its bottom 631 is depressed towards flow control assembly 632 the total volume of container 600C may shrink to occupy a very low volume. According to yet additional or alternative embodiments of container 600C, its specific construction may be utilized to produce pressure inside container 600C when it is filled with liquid by providing constant pressure onto container bottom 631.

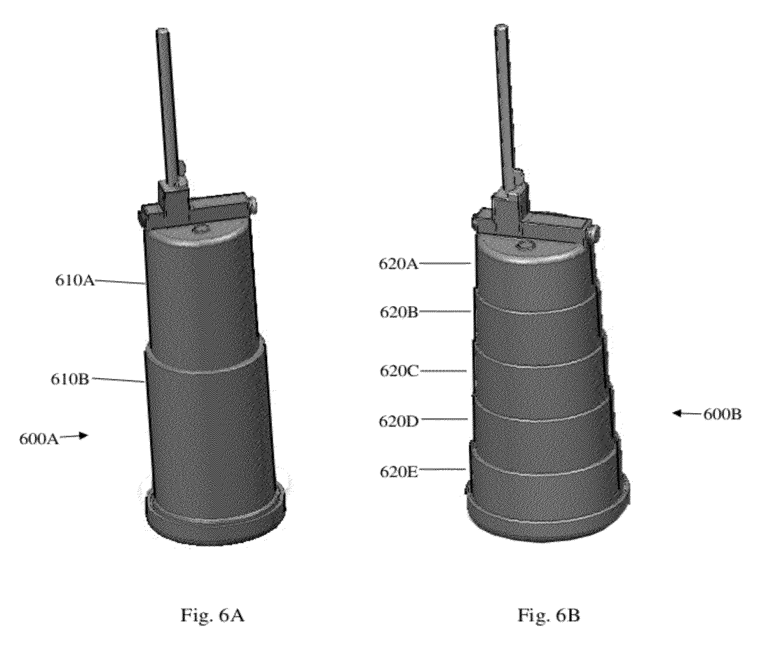

According to embodiments of the present invention one of a variety of working heads may be adapted, formed, connected or attached at the end of the dispensing tube to provide treatment effects additional to the cleaning effect of the pressurized liquid jets from the dispensing orifice. Reference is made now to FIGS. 7A, 7B and 7C which schematically illustrate dental treatment hand tool 700 in partial isometric view, partial top view and partial side view which is partially transparent, respectively, according to embodiments of the present invention. The partial views present the distal end of hand tool 700, which is formed to allow cleansing of the interior of the user's mouth using brush elements, pressurized liquid and vacuum effect.

Hand tool 700 may comprise hand tool body 701 having a long bore 702 made inside it along its longitudinal dimension to allow providing of pressurized liquid and/or pressurized gas to centrifugal turbine spindle 704. Centrifugal turbine spindle 704 may have a general shape of a cylinder that may be installed in hand tool body 701 so that it may turn about rotation axis 704A. Centrifugal turbine spindle 704 may comprise two main parts: impeller 704B centrifugal cone 704C Impeller 704B may be located away from the working end of hand tool 700 and closer to bore 702. Centrifugal cone 704C may be located closer to the working end of hand tool 700 (e.g. to brush elements 740) Impeller 704B may be used as the rotation support of centrifugal turbine spindle 704, being placed in a corresponding bore in hand tool 700 Impeller 704B may be made according to any desired design which will allow it to rotate when pressurized fluid hits it. The rotation of impeller 704B causes the rotation of centrifugal cone 704C Impeller 704B of centrifugal turbine spindle 704 may be formed to have one or more turbine-like blades made to react to a flow of pressurized liquid or gas by producing high-speed rotation of centrifugal turbine spindle 704. Centrifugal cone 704C of centrifugal turbine spindle 704 may be formed as a cone having its main axis coinciding with rotation axis 704A. When centrifugal turbine spindle 704 turns in a high enough rotation speed the air next to cone 704D follows the rotation and a local cyclone-like phenomenon develops next to the outer surface of rotating cone 704D. This phenomenon force molecules of air to be thrown from the center of the cyclone to outside of that center, as depicted by arrows 720. The constant movement of air in a cyclone form away from the center of cone 704D causes local vacuum or substantial drop of local pressure, which in turn causes movement of air back towards the center of cone 704D as depicted by arrows 730. This movement of air may be utilized to invoke vacuum inside the mouth when hand tool 700 is used to take care of the mouth interiors. According to yet additional embodiments of the present invention the jet of pressurized liquid leaving turbine element of centrifugal turbine spindle 704 it may be directed (not shown in FIGS. 7A, 7B and 7C) towards the interior of the mouth to achieve the goals described above.

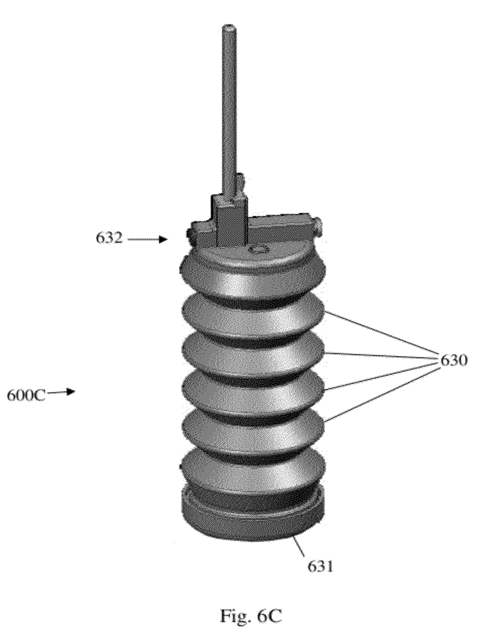

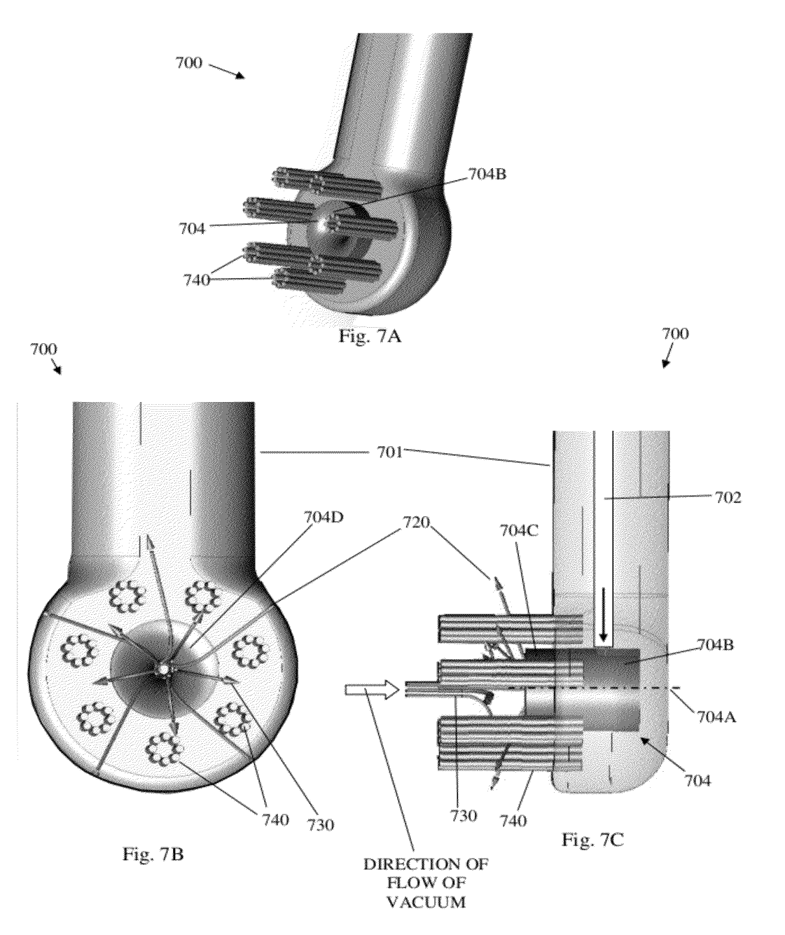

Reference is made now to FIGS. 8A and 8B, which are schematic partial cross section top and side views of hand tool 800 for cleansing the teeth and mouth according to embodiments of the invention. Hand tool 800 may comprise long bore 802 made inside it along its longitudinal dimension to allow providing of pressurized liquid and/or pressurized gas. Pressurized fluid bore 802 may end with a narrowing fluid way 804 which may be formed to provide the pressurized fluid into engraved toroidal space 806 in a tangential direction via fluid outlet 804A. Toroidal space 806 ids made to fit the size of ball 808, so that when ball 808 is urged to turn around inside toroidal space 806 it may turn freely but at the same time to provide good sealing between ball 808 when it turns around and the inner face of toroidal space 806. Hand tool 800 may further comprise outlet orifice 810 allowing the exit of a jet of pressurized fluid from the hand tool. When pressurized fluid enters toroidal space 806 via bore 802 and fluid way 804 it causes a vortex movement inside toroidal space 806 which turns in the direction of the arrow marked in toroidal space 806 of FIG. 8A. As a result ball 808 turns in the same direction and substantially in the same speed of the vortex. Each time ball 808 passes over fluid outlet 804A it blocked it for a short while, thus causing intermittent flow of the pressurized fluid into and out of toroidal space 806. Accordingly, the pressurized fluid jet that emerges from outlet orifice 810 in pulsating manner. Further, the speedy turning of ball 808 cause two-dimensional vibrations of hand tool 800 which are substantially in the plane of FIG. 8A. The rate of vibrations may be in the range of few hundreds to few thousands of vibrations per minute. However, other frequencies may be selected by the clever selection of the size and weight of ball 808 and/or the pressure of the pressurized fluid.

Reference is made now also to FIG. 8C which is a schematic isometric view of hand tool 850, similar to hand tool 800 of FIGS. 8A and 8B, with added brush ring 852, according to embodiments of the present invention. Hand tool 800 may have a protruding installation rim 812, made to allow the installation, per the needs of the user, of brushes ring 852 on hand tool such as hand tool 800. Brushes ring 852 may comprise installation ring 852A and a plurality of brush bundles 852B installed around the circumference of installation ring 852A so that the brush bundles 852B protrude from ring 852A substantially vertically to the plane of ring 852B. When pressurized fluid flows into hand tool 850 its end vibrates in combined two directions, as indicated by the four-ended arrow and pulsating pressurized fluid jets out of fluid outlet orifice 810, thus providing a two action dental care hand tool. The combined two-directional movement may typically has the form of a closed loop, such as a circle or an ellipsoid. It will be apparent to those skilled in the art that hand tool add-ons other than brush ring 852 may be attached to hand tool 800 for taking advantage of the two-action (pulsating and vibrating) phenomena of hand tool 800 or 850.

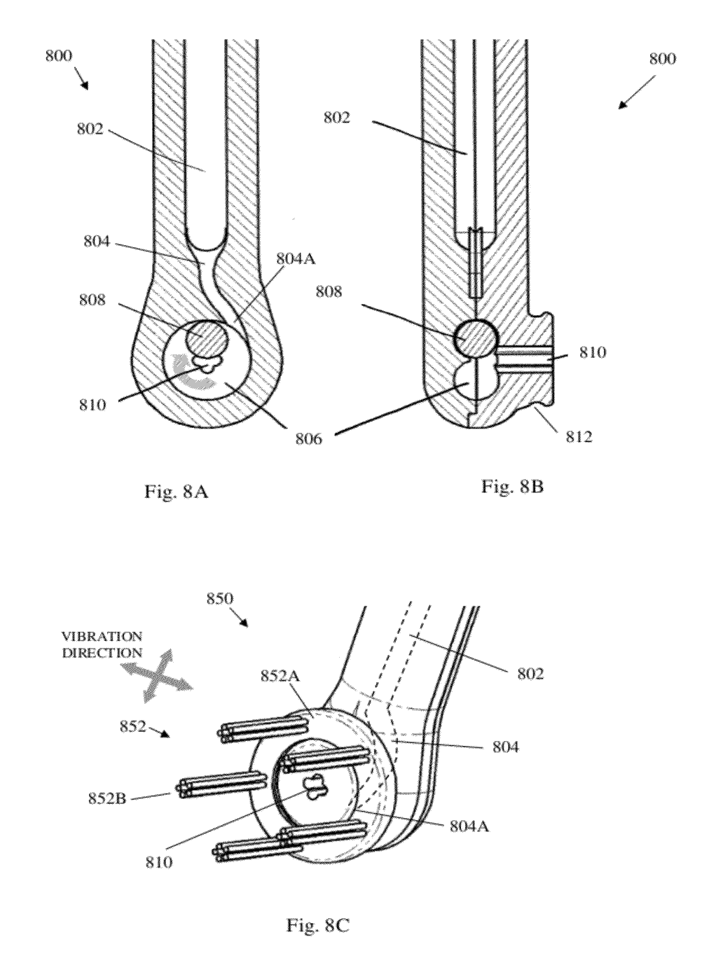

Reference is made now to FIGS. 9A and 9B, which are partial cross section side view and isometric view of hand tool 900 according to embodiments of the present invention. Hand tool 900 may comprise long bore 902 made inside it along its longitudinal dimension to allow providing of pressurized liquid and/or pressurized gas. Bore 902 may be formed to provide pressurized fluid into toroidal space 906 in a tangential manner, so to cause rotational speedy movement of ball 910 in the plane of FIG. 9A. The rotational movement of ball 910 may cause two-dimensional combined vibration as indicated by the four-head arrow. This combined two-dimensional movement typically has the form of a closed loop, either circle-like, ellipsoid-like, etc. The speedy movement of ball 910 over the entrance of bore 902 into toroidal space 906 causes intermittent flow of the pressurized fluid into and out of toroidal space 904. Accordingly, the pressurized fluid jet that emerges from outlet orifice 908 in pulsating manner. Thus, a two-action hand tool is disclosed, providing pulsating pressurized jet of fluid and vibrating tool. Here also ad-on tools, such as brush ring 852 of FIG. 8C, may attached to hand tool 900, as may be required.

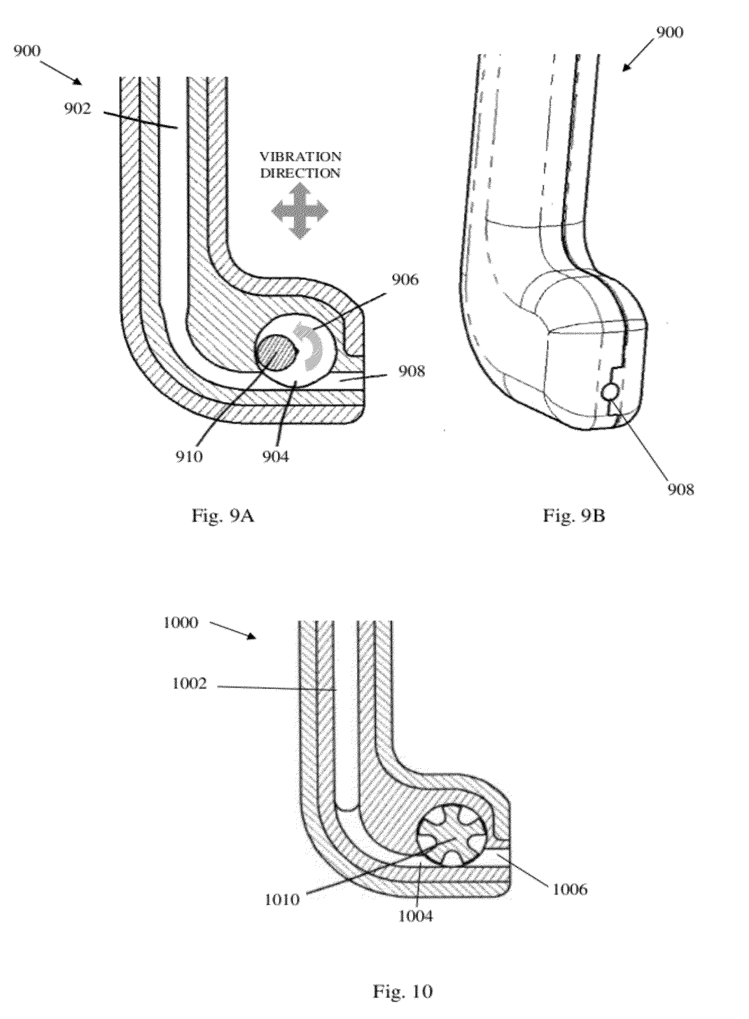

Reference is made now to FIG. 10, which is a schematic partial cross section side view of hand tool 1000, according to embodiments of the present invention. Similarly to hand tools 800 and 900, pressurized fluid flowing via bore 1002 and through formed fluid way 1004 causes wheel 1010 to turn, on its way to fluid orifice 1006. As a result intermittent flow of the pressurized fluid is caused, rendering pulsating flow of pressurized jet through outlet orifice 1006.

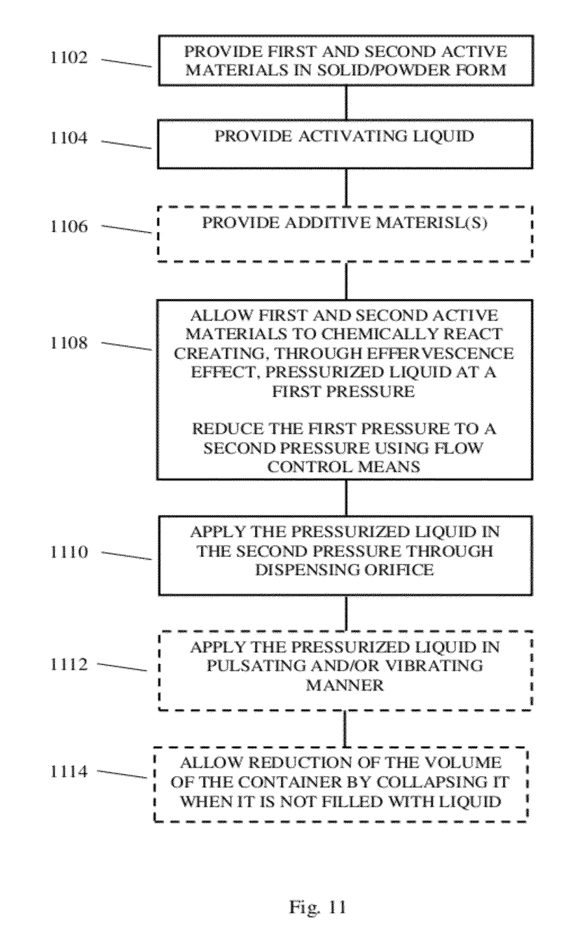

Reference is made now to FIG. 11, which is a flow diagram depicting operation of a dental care apparatus according to embodiments of the present invention. A first active material and a second active material are provided (block 1102). The first active material may be, for example, baking soda or sodium bicarbonate, included in a tablet or a powder packed in a porous bag. The second active material may be citric acid or tartaric acid, included in a tablet or a powder packed in a porous bag. Activating fluid, such as water or other kinds of liquid may be provided (block 1104). Before activation the first and second active materials, in a tablet and/or powder form, are kept in a first compartment inside a container, as explained in details above. Optionally additives of various kinds and for various purposes may also be provided (block 1106), as discussed in details above.

The first and second active materials are allowed to chemically react (block 1108). The activation may begin after the container has been filled (or re-filled) with liquid, the tablet has been inserted into its compartment and the container is turned so that the tablet compartment is at the lower end of the container and the liquid in the container is allowed to react with the tablet's materials. The chemical reaction liberates gas (such as carbon dioxide) through effervescent effect (block 1108). The effervescence effect causes the pressure in the container to rise to a first pressure level. When liquid in the first pressure level is provided through flow control means which comprise pressure regulator that is adapted to reduce the pressure passing the flow control means to a second pressure level (block 1108). When the flow control means is switched to ON, pressurized liquid in the second pressure level is provided via dispensing tube and dispensing orifice (block 1110). Optionally working heads of various types may be adapted at the end of the apparatus to provide the pressurized liquid through the orifice in one or more of various manners such as pulsating manner, vibrating manner, using brush, and the like (block 1112). When the apparatus is not filled with water the volume of its container may be reduced by collapsing its two or more collapsible container elements into each other (block 1114).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An apparatus comprising:
a container partitioned into a first compartment and a second compartment by a partition adapted to allow free flow of liquid through said partition;
said first compartment adapted to contain liquid;
said second compartment adapted to receive a first and a second active material;
a back cover adapted to close a first end of said container, said first end is closer to said second compartment; and
an operation control means to control dispensing of pressurized liquid from said container, said operation control means installed on a front cover closing the second end of said container;
wherein said first active material and said second active material to produce a first pressure from an effervescence process when in a chemical reaction and said operation control means to reduce said first pressure to a second pressure, said second pressure is kept constant regardless of the orientation of said container with respect to the gravity direction.

2. The apparatus of claim 1 further comprising dispensing tube connected at a first end to said operation control means to receive pressurized liquid in said second pressure and to dispense said pressurized liquid via a dispensing orifice.

3. The apparatus of claim 2 further comprising pulsating mechanism to provide said pressurized liquid to said dispensing orifice in at least one pulse.

4. The apparatus of claim 3 wherein the number of said pulses in a time interval is controllable.

5. The apparatus of claim 1 wherein said container is collapsible when not filled with liquid.

6. The apparatus of claim 5 wherein said collapsible container is comprised of two or more container elements adapted to collapse into each other when n collapsed position and to extend to form a container in a sealable manner when in an operational position.

7. The apparatus of claim 2 wherein said dispensing tube comprising a working head adapted at its second end.

8. The apparatus of claim 7, wherein said working head is one from a group comprising a vibrating head, a vibrating head with brush, a vibrating head with pulsating mechanism and a pulsating mechanism.

9. The apparatus of claim 1 wherein said operation control means comprise on/off control means, pressure control means and safety bleed valve.

10. A method comprising:
providing an apparatus for applying dental treatment;
providing a first active material enclosed in said apparatus;
providing a second active material enclosed in said apparatus;
providing liquid enclosed in said container;
allowing said second active material to chemically react with said first active material thereby creating an effervescent effect;
providing pressurized liquid in a first pressure level using said effervescence effect;
controllably providing pressurized liquid in a second pressure level, said second pressure level is lower than said first pressure level and is substantially constant during the operation of said apparatus, regardless of the orientation of said container with respect to the gravity direction.

11. The method of claim 1 further comprising providing pulsating means to allow provision of said pressurized liquid in said second pressure level in pulses.

12. The method of claim 11, wherein the rate of said pulses is controllable.

13. The method of claim 10 further comprising collapsing said container to reduce its volume when said apparatus is not filled with liquid.

14. The method of claim 13 wherein said collapsing of said container comprise collapsing of two or more container elements.

15. The method of claim 10, wherein the providing of the pressurized liquid in said second pressure level is done using a working head.

16. The method of claim 15 wherein said working head is one from a group comprising a vibrating head, a vibrating head with brush, a vibrating head with pulsating mechanism and a pulsating mechanism.

17. The method of claim 10, wherein the step of controllably providing pressurized liquid in a second pressure level comprise:
controlling allowing/blocking flow of said pressurized liquid to said dispensing tube
reducing said first pressure level to provide constant second pressure level; and
providing bleed passage to allow pressure over a third pressure level to be released from said container.

18. The method of claim 10 further comprising providing a flexible supply tube inside said container said flexible supply tube is installed with a weight at its input end to allow constant supply of liquid from said container at any orientation of the container.
